(19) United States
(12) Patent Application Publication
(10) Pub. No.: US 2010/0208342 A1
(43) Pub. Date: Aug. 19, 2010

(54) METHODS AND SYSTEMS FOR CREATING PASSIVE STEREO 3D IMAGES

(75) Inventor: Kjell Einar Olsen, Krakerey (NO)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: projectiondesign as, Gamle (NO)

(21) Appl. No.: 12/388,744

(22) Filed: Feb. 19, 2009

(51) Int. Cl. G02B 27/22; G03B 27/14

(52) U.S. Cl. 359/464; 353/7

(57) ABSTRACT

Methods and systems are provided for creating passive 3D images. A color modulator having at least six filters is used to send light to a single imager in respective RGB spectrums during successive time periods for a left-eye image and then in a different RGB spectrum for a right-eye image, or vice versa. Resulting 3D imaging systems can use a single projector and a single imaging chip without the need for specialized display surfaces, and thus are inexpensive to build and have a low maintenance cost. In addition, better color properties between the left and right images may be provided with a color spectrum of a first image having at least two peaks that surround a peak of the corresponding color for the second image. A color shift of the images may thus be decreased without a loss in other color properties.

### BACKGROUND

The present invention generally relates to creating stereoscopic three dimensional (3D) images, and more particularly to using differing light spectrums to provide such 3D images.

When a person views a single two dimensional (3D) image, the person does not see depth or may miss detail of an image. Three dimensional images can provide greater viewing pleasure and detail to an audience. Stereoscopic three dimensional images may be created by providing different images to each eye. However, current methods are expensive and/or provide inferior quality.

Historically, a 3D image was created by providing two images, e.g., side-by-side, of a same scene. In another example, a person looks through two separate eye holes to see two different images.

Later, anaglyph 3D images and movies were created in which a person can see 3D images by using glasses. To create a 3D image, two images from the perspective of the left and right eyes were projected or printed together as a single image. The image for the left eye was printed in red, and the image for the right eye was printed in blue and/or green. A person then wears glasses that filter light so that the left eye only sees red and the right eye only sees blue and/or green. However, the images can be blurry and do not offer bright, accurate, and consistent color.

Recently, stereoscopic 3D images have been created using active glasses. In the headset, the lens for one eye becomes opaque while the other eye is able to view a first image. For the next image, the lens for the other eye becomes opaque while the first eye can see the next image. The images on a screen alternate between a left eye image and a right eye image. In other words, the lenses turn off and on so that the left eye only sees the left image and the right eye only sees the right image is seen. This mechanism can provide bright and accurate color; however, the glasses can be quite expensive. Also, the synchronization of the glasses and the images can be problematic, thus destroying the three dimensionality of the images.

To solve, the problem of expensive glasses, other method use passive techniques. One such method uses polarization. However, the use of polarization requires specific materials for a display screen, and thus not easily applied to home 3-D broadcast.

Other passive methods use wavelength multiplexing instead of polarization. However, these methods have similar color issues as the anaglyph 3D images. Also, standard systems implementing this method as well as active methods use two projector solutions, where one projector transmits the left-eye images and another projector transmits the right-eye images. The use of two projectors at least doubles the cost of a 3D system. On 2 projector solutions, an alignment of projected image is necessary and is critical, as well as the cost and maintenance of 2 projectors is significant higher than the for a single projector.

Three chip panel projectors can in some cases be used as a single projector for passive stereo. However, a three panel projector is a big and expensive projector for fixed installation systems, which are not easy portable.

Therefore, it is desirable to have systems and methods for displaying 3D images in an inexpensive and portable manner with high color consistency and clarity.

### BRIEF SUMMARY

Embodiments of the present invention provide methods and systems for providing passive 3D images that may be viewed via a single projector that has a single-chip. As the 3D images are passive, expensive glasses are not needed. Also, since a single projector having only a single chip may be used, the systems provide low cost and maintenance. Additionally, as embodiments do not use polarization, specialized surfaces are not required for display of the 3D images. In addition, embodiments provide better color properties (e.g. less color shift between the left-eye images and the right-eye images) than other passive 3D solutions not using polarization.

According to an exemplary embodiment, an image projector for creating one or more stereoscopic three dimensional images comprising left-eye images and right-eye images is provided. A light source provides light to an imager that creates left-eye images and right-eye images. A color modulator modulates light transmitted from the light source to the imager and includes two sets of filters, with one filter modulating the light at any one instant in time.

The first set of filters includes first red, green, and blue filters that transmit light according to a first red, green, and blue spectral distributions, respectively. The second set of filters includes second red, green, and blue filters that transmit light according to a second red, green, and blue spectral distributions, respectively. A controller synchronizes the color modulator with the imager such that when a left-eye image is being created by the imager, each one of the first set of filters are used to modulate the light at different time periods during the creation of the left-eye image. When a right-eye image is being created by the imager, each one of the second set of filters are used to modulate the light at different time periods during the creation of the right-eye image.

According to another exemplary embodiment, a method of creating one or more stereoscopic three dimensional images comprising left-eye images and right-eye images is provided. To create a left-eye image, light is provided to an imager in a first red spectrum during a first time period, in a first green spectrum during a second time period, and in a first blue spectrum during a third time period. To create a right-eye image, light is provided to the imager in a second red spectrum during a fourth time period, in a second green spectrum during a fifth time period, and in a second blue spectrum during a sixth time period. The first to sixth time periods do not overlap in time.

According to yet another exemplary embodiment, a method of creating one or more stereoscopic three dimensional images comprising left-eye images and right-eye images is provided. A first image (e.g. a left-eye image) of a stereoscopic three dimensional image is created by respectively controlling an intensity of light to be displayed in a first red spectrum, a first green spectrum, and a first blue spectrum for a plurality of pixels of the first image. A second image (e.g. a right-eye image) of the stereoscopic three dimensional image is created by respectively controlling the intensity of light to be displayed in a second red spectrum, a second green spectrum, and a second blue spectrum for a plurality of pixels of the second image. At least one of the first spectrums has at least two peaks that are centered around a peak for the corresponding color of the second spectrum.

According to yet another exemplary embodiment, an imaging system for creating one or more stereoscopic three dimensional images comprising left-eye images and right-eye images is provided. At least one imaging device (e.g. a DMD chip or a liquid crystal molecule) controls an intensity of light in a first red spectrum, a first green spectrum, and a first blue spectrum for one or more pixels of a first image. The same or another imaging device controls an intensity of light in a second red spectrum, a second green spectrum, and a second blue spectrum for one or more pixels of a second image. At least one of the first spectrums has at least two peaks that are centered around a peak for the corresponding color of the second spectrum.

In one embodiment, the imaging system is a projection system. In another embodiment, the imaging device is flat panel display that, for example, uses separate imaging devices for each color of each pixel.

As used herein, the term spectrum and spectral distribution are used interchangeably. Both refer to the intensity of a particular sample of light at particular wavelengths. For example, a spectrum has non-zero values of intensity over the wavelengths of that spectrum.

As used herein, a red spectrum is not restricted to any traditionally held range for red, but simply means that some viewable intensity of the spectrum is in the range of 570-750 nm. Similarly, a green spectrum is considered to have at least some spectrum in the range 480-600 nm. A blue spectrum is considered to have at least some spectrum in the range 400-520 nm. Thus, a spectrum of traditionally viewed spectrums in yellow, cyan, and violet will still correspond to the defined red, green, and blue spectrums.

A better understanding of the nature and advantages of the present invention may be gained with reference to the following detailed description and the accompanying drawings.

### BRIEF DESCRIPTION OF THE DRAWINGS

FIG. 1 shows a generalized schematic for the viewing of stereographic 3D images according to embodiments of the present invention.

FIG. 2 is a block diagram of an image projector 200 that creates one or more stereoscopic 3D images according to an embodiment of the present invention.

FIG. 3A shows a color modulator 300 having at least six color filters according to an embodiment of the present invention.

FIG. 3B shows viewer glasses with left-eye and right-eye filters that transmit spectrums consistent with the filters of color modulator 300 according to an embodiment of the present invention.

FIG. 4 is a flowchart illustrating a method 400 of creating stereoscopic three dimensional images according to an embodiment of the present invention.

FIG. 5A shows blue spectrums for right-eye and left-eye images having no spectrum overlap, but exhibiting a color shift between the left and right images.

FIG. 5B and 5C show blue spectrums for the left-eye and right-eye images that do not exhibit a significant color shift according to an embodiment of the present invention.

FIG. 6 shows a series of plots depicting the spectrums of red, green, and blue spectrums for the left-eye and right-eye images according to an embodiment of the present invention.

FIG. 7 shows a series of graphs depicting the spectrums for the left-eye and right-eye filters in the lenses of the viewer and the spectrum of a light source according to an embodiment of the present invention.

FIG. 8 is a chart of the color coordinates of the image, for right/left eye information according to an embodiment of the present invention.

### DETAILED DESCRIPTION OF EXEMPLARY EMBODIMENTS

Embodiments of the present invention provide methods and systems for providing passive 3D images that may be viewed via a single projector that has a single-chip. As the 3D images are passive, expensive glasses are not needed. Also, since a single projector having only a single chip may be used, the systems provide low cost and maintenance. Additionally, as embodiments do not use polarization, specialized surfaces are not required for display of the 3D images. In addition, embodiments provide better color properties (e.g. less color shift between the left-eye images and the right-eye images) than other passive 3D solutions no using polarization.

### I. Introduction

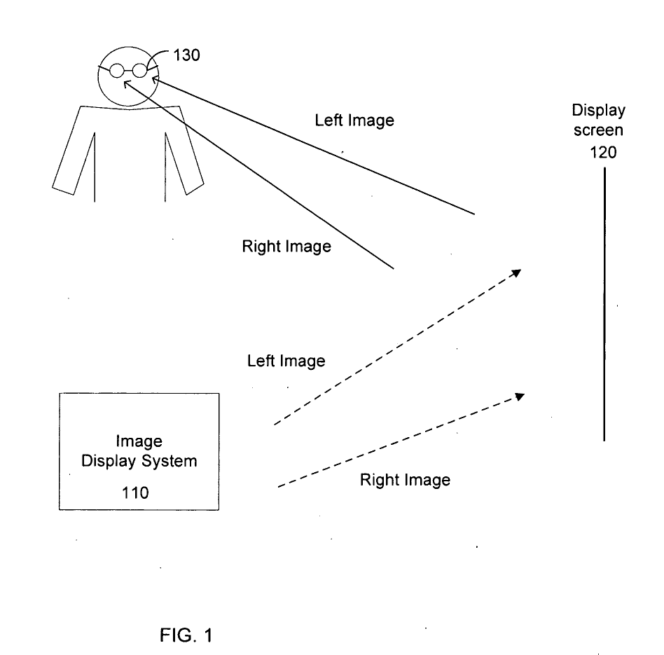

FIG. 1 shows a generalized schematic for the viewing of stereographic 3D images according to embodiments of the present invention. The 3D image is created as a composite of two different images, or for 3D video two different sets of images. One set of images are seen by the left eye and the other set of images are seen by the right eye. When the images correspond respectively to a left eye perspective and right eye perspective, the image appears to have depth to the viewer.

The image display system 100 displays a set of left images and a set of right images onto the display screen 120. In other embodiments, the system 100 may be behind the display screen 120. Examples of display systems that project images are liquid crystal on silicon (LCos), liquid crystal displays (LCD), and digital light projection (DLP). In yet other embodiments, the system 100 may be part of the display screen, e.g., in LCD flat panel or plasma displays. The system 100 creates images by controlling the intensities of the red, green, and blue colors of each pixel of the image.

In order to view the stereographic 3D images, a person wears specialized glasses 130. The glasses 130 have different filters for each eye. The left eye piece of the glasses 130 only allows light from the left images to be seen by the person. The right eye piece of the glasses 130 only allows light from the right images to be seen by the person. Thus, if the left images are displayed only in wavelengths that are transmitted by the left eye piece, then the left eye will only see the left images. Similarly, the right eye will only see the right images.

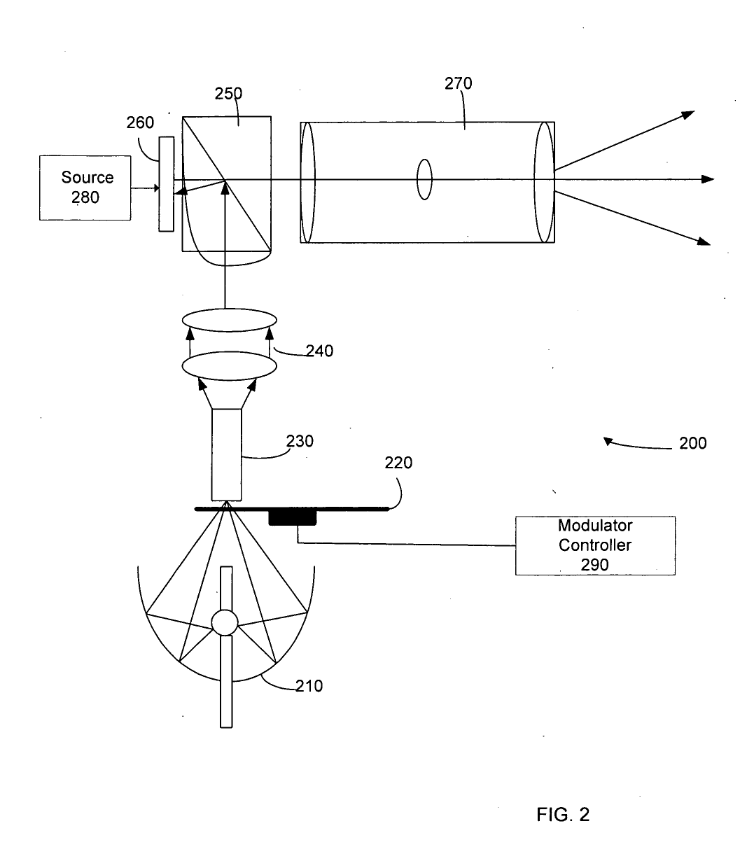

FIG. 2 is a block diagram of an image projector 200 that creates one or more stereoscopic 3D images according to an embodiment of the present invention. Image projector 200 provides left-eye and right-eye images sequentially in time. For example, a left-eye perspective view is displayed and then a right-eye perspective view is displayed, or vice versa. In this manner, only one image projector is required to provide a 3D.

The light source 210 provides electromagnetic radiation, also called light herein. The spectrum (i.e. the intensity for a given wavelength), also called spectral distribution, of the light is at least partially within the visible range (i.e. the spectrum has wavelengths that are detectable by the eye). In one embodiment, the light source 210 is a single lamp (e.g. an arc lamp). In one embodiment, the light source is composed of multiple lamps, e.g., as described in U.S. application Ser. No. 12/266,384 “HIGH INTENSITY IMAGE PROJECTOR USING SECTIONAL MIRROR” (Attorney Docket No. 027467-000500US), which is herein incorporated by reference.

Light from light source 210 is used by an imager 260 to create an image. For example, an imager 260 may have a mirror devoted to each pixel of an image. Each mirror can be moved to reflect a desired amount of light into an aperture to provide the appropriate amount (intensity) that a color contributes to a pixel. As another example, an imager may transmit the desired amount of light.

As the image projector 200 creates the left-eye and right-eye images sequentially, the imager 260 will create the left-eye image and then create the right-eye image, or vice versa. In one aspect, in creating a left-eye image, the imager receives light in a green spectrum and provides light at the appropriate green intensities for the pixels of the left-eye image. Similarly, but during different time periods, the red and blue portions of the left-eye image are created, as well as the colors for the right-eye image.

In order to provide different colors of light, a color modulator 220 is placed in an illumination beam of the light source 210. The color modulator 220 has different filters that transmit wavelengths corresponding to a desired spectrum (e.g. a desired color), and does not transmit wavelengths in non-desired spectrums or colors.

In an example using a DLP imager, the spectrum generated from the color modulator 220 is integrated in light integrator 230, e.g. of hollow type. The light, which may be uniformly integrated, is collected by relay optics 240 and reflected in the total internal reflection (TIR) surface of the prism 250 for illumination onto the imager 260. In one embodiment, a single chip (e.g. a digital micromirror device (DMD)) is used for the imager 260. In other embodiments, more than one chip may be used, with each chip being used sequentially, e.g., one chip providing input to another chip.

In one embodiment, the imager 260 is tilted (e.g. ±12 degrees) from an “on” position to an “off” position. When the imager 260 is in the “on” position, the light reflected is transmitted through the TIR prism 250 and focused on the screen by the projection lens 270. When the imager is in an “off” position, the imager is tilted −12 degrees. In the “off” position, the light reflected from the imager 260 will not transmit trough the TIR prism 250, but will be reflected in the TIR surface due to the reflective angle. In one aspect, this light reflected by the TIR surface is absorbed by an optical engine dump light area.

The operation of the color modulator 220 in combination with the image 260 is now described according to an embodiment of the present invention.

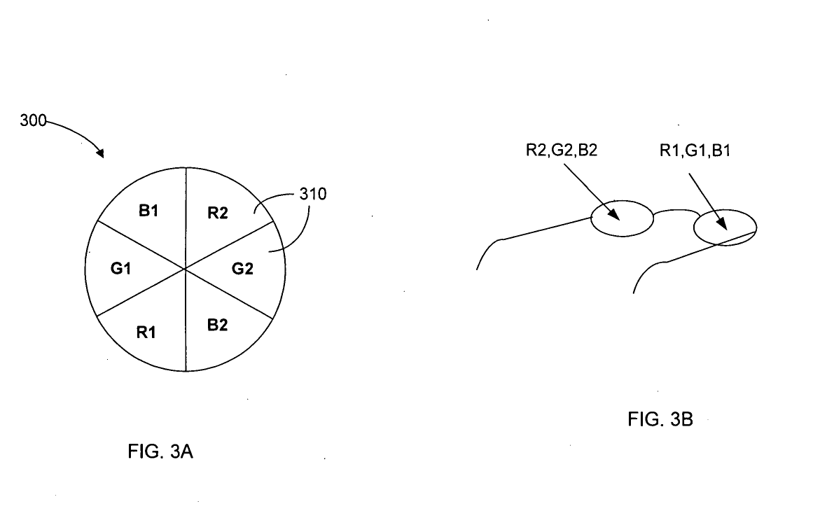

FIG. 3A shows a color modulator 300 having at least six color filters according to an embodiment of the present invention. In this embodiment, color modulator 300 is a wheel with different segment filters 310. One filter 310 is in front of the illumination beam at a time. The color wheel 300 transmits wavelengths in either a red (R), green (G) and blue (B) spectrum depending on which filter is currently in the illumination beam. Although six filter segments are shown, more filter segments may be used, such as a clear segment for controlling brightness and additional segments for a particular filter, e.g. two of each filter shown.

As mentioned above, to produce a 3D image, two different images are created: one for right eye and another for left eye. One image (e.g. for the right eye) is created using the filters marked R1, G1, and B1 and the other image (e.g. for the left eye) is created using the filters marked R2, G2, and B2. Note the filters for a particular image (i.e. left or right) may be switched. The sequence of the filters also may be in any order, e.g., R, B, G as one moves clockwise. The filters for one eye also do not have to be contiguous. The filters for different eyes may also be interspersed, e.g., R1, R2, G1, G2, B1, and then B2.

When a particular color spectrum is to be illuminated onto the imager 260 then the appropriate filter is put into the illumination beam. In one embodiment, when a source 280 of the image data (e.g. a graphics processor or a video stream from DVD) gives data corresponding to the right-eye image to the imager 260, the color wheel 300 spins so that the color spectrums for R1, G1, and B1 are transmitted. The imager 260 is synchronized with the spin of the color modulator 300 so that the correct filters are used at the desired times. For example, when the imager 260 is programmed to create the green of the right-eye image, then the color wheel 300 will have the G1 filter in the illumination beam.

In one embodiment, a controller 290 in FIG. 2 controls the spin of the color modulator to be synchronized with operation of the imager 260 that is consistent with the image data. The controller 290 may be part of the source 280, e.g., part of the graphics processor. The source 280 and controller 290 may also just be communicably coupled so that the synchronization occurs.

Normally, the imager 260 will be programmed to create the colors in sequential order, e.g. red then green and then blue. However, any order may be used. Also, the spectrums for a particular image may repeat, e.g., the spectrum R1 could be used twice for a single image.

When the source (e.g. a video engine or stream) gives data corresponding to the left-eye image to the imager 260, the color wheel 300 spins so that the color spectrums for R2, G2, and B2 are transmitted. The imager 260 is synchronized with the spin of the color wheel 300, and an image is created from the generated pixels and projected on the screen.

In other embodiments, the color modulator may also spin, but be of a different shape. In yet another embodiment, another mechanism besides spinning may be used to push filters in and out of the beam of light being transmitted, e.g., into the integrator 230.

FIG. 3B shows viewer glasses with left-eye and right-eye filters that transmit spectrums consistent with the filters of color modulator 300 according to an embodiment of the present invention. The right-eye lens transmits light within the spectrums of R1 and G1 and B1. Therefore, the right eye of the viewer sees the right images. The left-eye lens transmits light within the spectrums of R2 and G2 and B2. Therefore, the right eye of the viewer sees the right images.

In one aspect, the first spectrums (R1, G1, B1) do not appreciably overlap with the second spectrums (R2, G2, B2). Therefore, the right-eye of the viewer will only see the right-eye images, and left-eye of the viewer will only see the left-eye images. In other words, there will be little crosstalk or bleed over between the two sets of images. In one aspect, a non-appreciable overlap is about 10% or less. Such an overlap may be calculated by determining the area of the intensity curve that is common to both spectrums and dividing by the area of either one of the spectrums.

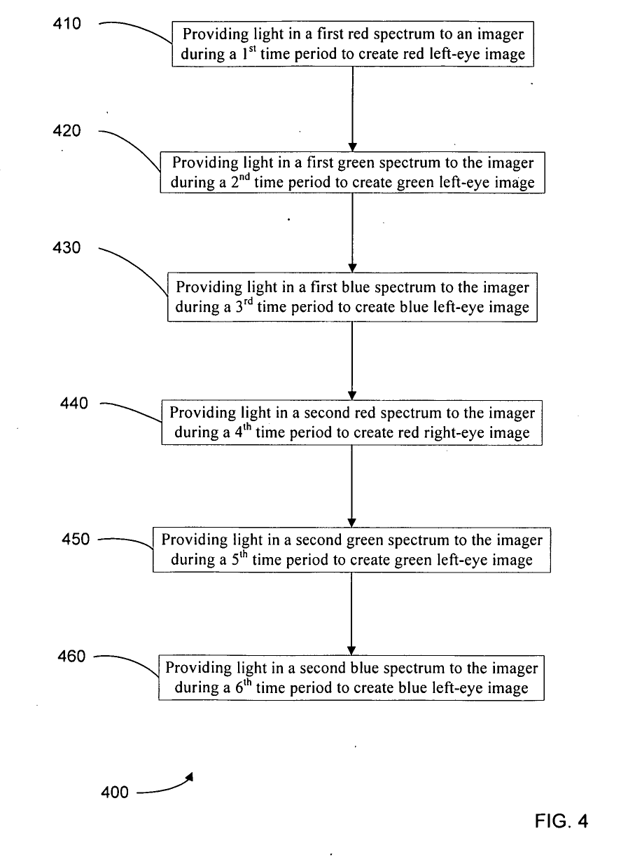

FIG. 4 is a flowchart illustrating a method 400 of creating stereoscopic three dimensional images according to an embodiment of the present invention. Method 400 may be implemented with system 200.

In step 410, light in a first red spectrum (e.g. R2) is provided to an imager (e.g. imager 260) during a first time period. For example, when the imager 260 receives data regarding an intensity of red light for each pixel of the left-eye image, then light in the first red spectrum is provided to an imager. The imager can then use light in the first red spectrum to create the red portions of the left-eye image during the first time period.

In step 420, light in a first green spectrum (e.g. G2) is provided to the imager during a second time period. For example, when the imager 260 receives data regarding an intensity of green light for each pixel of the left-eye image, then light in the first green spectrum is provided to the imager. The imager can then use light in the first green spectrum to create the green portions of the left-eye image during the second time period.

In step 430, light in a first blue spectrum (e.g. B2) is provided to the imager during a third time period. For example, when the imager 260 receives data regarding an intensity of blue light for each pixel of the left-eye image, then light in the first blue spectrum is provided to the imager. The imager can then use light in the first blue spectrum to create the blue portions of the left-eye image during the third time period.

In step 440, light in a second red spectrum (e.g. R1) is provided to the imager during a fourth time period. For example, when the imager 260 receives data regarding an intensity of red light for each pixel of the right-eye image, then light in the second red spectrum is provided to the imager.

In step 450, light in a second green spectrum (e.g. G1) is provided to an imager (e.g. imager 260) during a fifth time period. For example, when the imager 260 receives data regarding an intensity of green light for each pixel of the right-eye image, then light in the second green spectrum is provided to the imager.

In step 460, light in a second blue spectrum (e.g. B1) is provided to an imager (e.g. imager 260) during a sixth time period. For example, when the imager 260 receives data regarding an intensity of blue light for each pixel of the right-eye image, then light in the second blue spectrum is provided to the imager.

Accordingly, the left-eye image is created using steps 410-430. In one embodiment, the 1^{st}-3^{rd} time periods occur sequentially in any order. For example, the order may be red, green, blue or green, red, blue and so on. The order may repeat so that other time periods may contribute to the left-eye image. The right-eye image is created using steps 440-460. In one embodiment, the 4^{th}-6^{th} time periods occur sequentially in any order. In one aspect, the different time periods do not overlap in time.

In one embodiment, the first red spectrum is provided using a red filter that receives light in a broad spectrum and transmits light in the first red spectrum. In another embodiment, the light may be provided with a red light emitting diode (LED) or laser that produces light in the first red spectrum. The light for the other spectrums may be provided in similar fashions.

As stated previously, the spectrum for R1 and R2 as well as G1 and G2, B1 and B2 can have a spectral distribution without an overlap in wavelength to avoid any cross talk between right and left eyed image. However, such lack of overlap can cause a color shift between the eyes, depending on how such spectrum are created. Accordingly, embodiment provide a lack of overlap with no color shift.

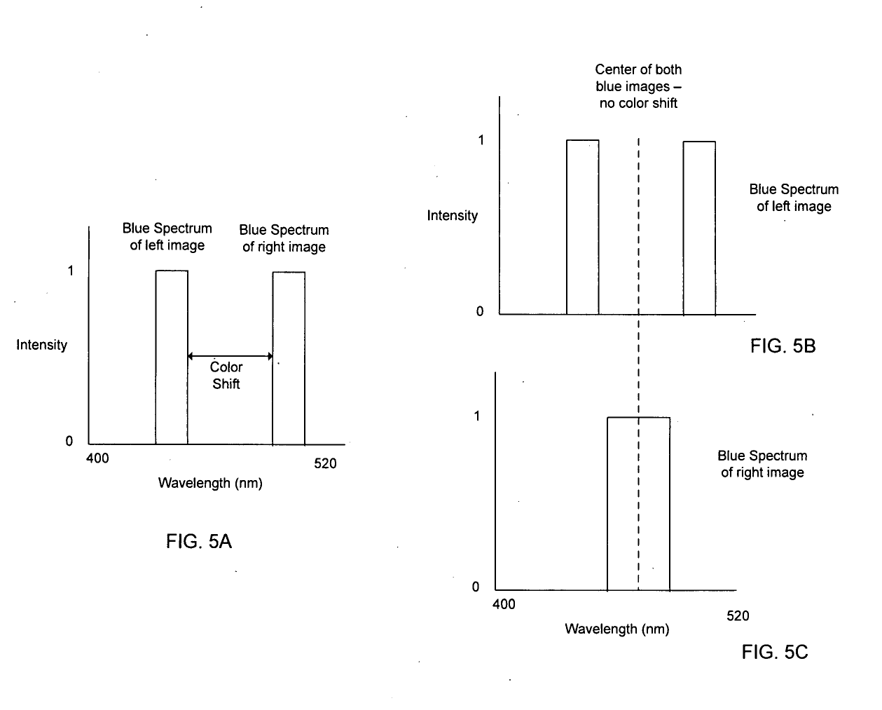

FIG. 5A shows blue spectrums for right-eye and left-eye images having no spectrum overlap, but exhibiting a color shift between the left and right images. When the left-eye image is shown, the image has a blue with a color of around 440 nm. When the right-eye image is shown, the image has a blue with a color of around 500 nm. Since each eye is seeing a different color of blue for the same image, a color shift between the two images is seen. Such a color shift effect detracts from a viewer's perception of the image.

FIGS. 5B and 5C show blue spectrums for the left-eye and right-eye images that do not exhibit a significant color shift according to an embodiment of the present invention. In FIG. 5B, the spectrum for the first blue spectrum of the left-eye image has two peaks. The center of these two peaks is about 470 nm. Accordingly, the average color seen by a viewer would correspond to the color at about 470 nm. Note that even if the left peak appears more violet and the right peak appears more greenish, the combination can provide a suitable blue color in the final image.

FIG. 5C shows a second blue spectrum for the right-eye. The center of this peak is also about 470 nm. Thus, there is no color shift. In this embodiment, the blue spectrum shown for the right image has a single peak. However, this blue spectrum may have additional peaks as well. As the average color for the two spectrums are about the same, then a viewer will not detect a color shift. Accordingly, in one embodiment, the colors are modulated so that, e.g., the R1 and R2 spectrums have similar color coordinates, but different spectrum, so the viewer can not see color shift between right and left images.

In an embodiment, color shift of x color coordinate and y color coordinate of about 0.04 or less for R,G,B,W would not be noticeable to a stereo 3D viewer. The colors are defined in color coordinates, described as -x and -y value, according to CIE 1931 color space. For example, green has an x and y value for the color of right image and another x and y value for the left image. A difference between the x values and a difference between the y values of about 0.04 or less would not be noticeable for a stereo 3D viewer.

As another advantage, the blues for each image can be made fuller as the width of each spectrum can be made quite large. In contrast, two narrow peaks placed close together may provide a smaller color shift; but then each blue spectrum only provides a limited amount of blue wavelength, which limits the ability to provide a full range of colors for each image. Additionally, the total blue range for both images is quite small.

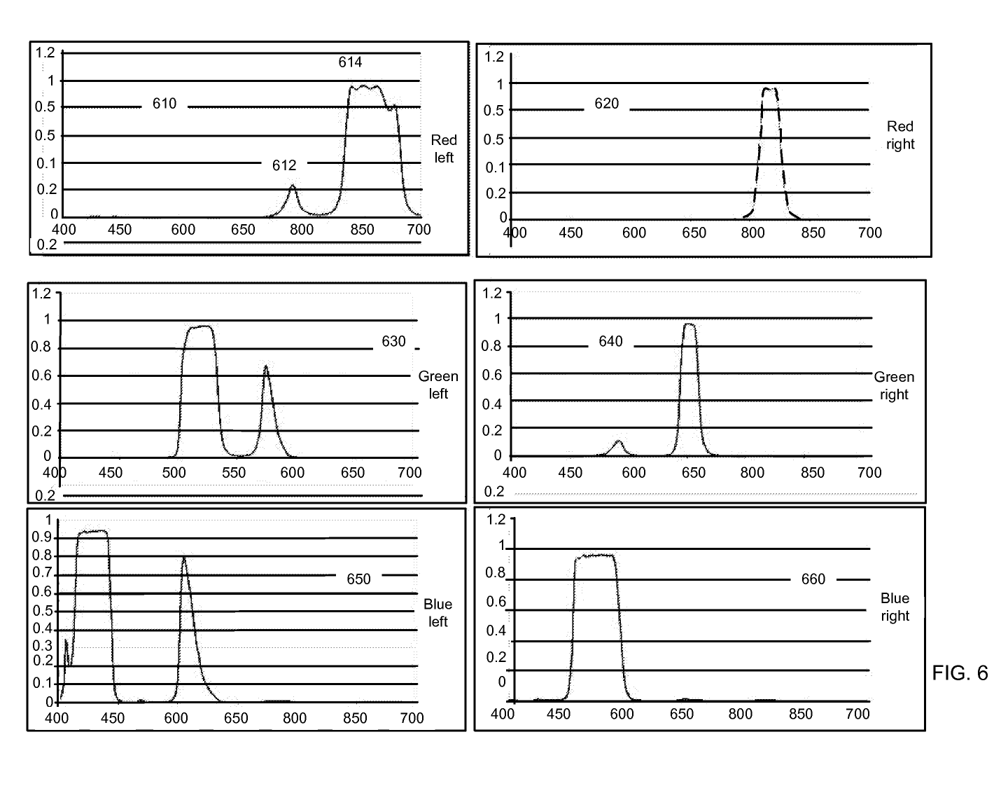

FIG. 6 shows a series of graphs depicting the red, green, and blue spectrums for the left-eye and right-eye images according to an embodiment of the present invention. The Y axis refers to the intensity of the light in arbitrary units. For example, this may be the intensity transmitted by a particular filter or produced from a particular type of LED. The X axis is the wavelength in nm.

Graph 610 shows a first red spectrum, which is for the left-eye in this embodiment. Graph 620 shows a second red spectrum, which is for the right-eye in this embodiment. Notice that the two peaks of graph 610 do not have to be the same height. The height of the small peak 612 may be varied to alter exactly how much the average is pulled to the left from the major peak 614. Thus, the average wavelength of a spectrum is related to the intensities of the peaks and not just a simple average of the wavelength position of the two peaks.

Also, although the small peak 612 is more in the yellow wavelengths, but the total spectrum is reddish. As mentioned herein, the use of the term red spectrum does not limit the appreciable value of intensities to specifically be in wavelengths traditionally associated with the color red.

Graph 630 shows a first green spectrum, which is for the left-eye in this embodiment. Graph 640 shows a second green spectrum, which is for the right-eye in this embodiment. Notice that both of these spectrums have two peaks. Such use of small peaks may be used to fine tune the average wavelengths of the two spectrums to be similar. In one aspect, the use of two peaks for both spectrums allows the average to be on the boundary of the two largest peaks, and thus more in the center of the desired color spectrum (green in this case).

Graph 650 shows a first blue spectrum, which is for the left-eye in this embodiment. Graph 660 shows a second blue spectrum, which is for the right-eye in this embodiment. In this embodiment (e.g. graph 650), the smaller peak tends to have a point at the top as opposed to the major peak, which tends to have a flat top. Such construction can allow a more precise shift of the average wavelength from the major peak, but is not a necessary construction.

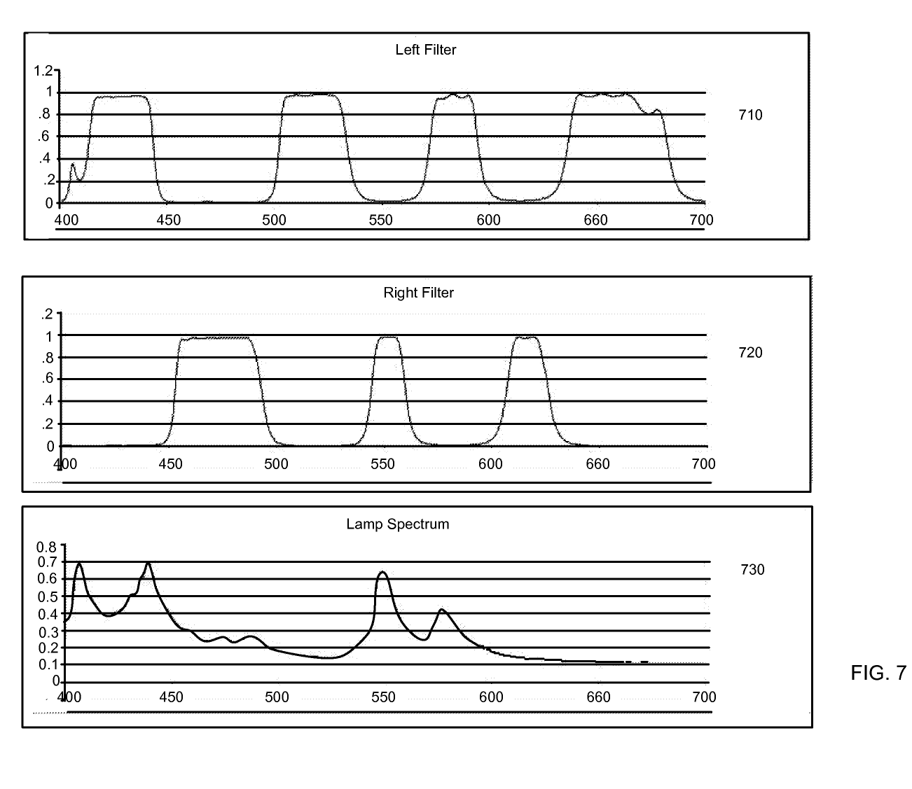

FIG. 7 shows a series of graphs depicting the spectrums for the left-eye and right-eye filters in the lenses of the viewer and the spectrum of a light source according to an embodiment of the present invention.

Graph 710 shows the spectrum that is transmitted by the filter in the left lens of the glasses (e.g. glasses in FIG. 3B) used by the viewer. Graph 710 corresponds to a composite of the of the first spectrums 610, 630, and 650 from FIG. 6. One consequence of having two peaks for each of these first spectrums is that the number of overall peaks is four, not three. If not all of the first spectrums had two peaks, then less than four final peaks in the spectrum of the glasses may be needed.

Graph 720 shows the spectrum that is transmitted by the filter in the right lens of the glasses. Graph 720 corresponds to a composite of the of the second spectrums 620, 640, and 660 from FIG. 6. In one aspect, as the two spectrums do not overlap, the left eye of the viewer will not see the right-eye images, and the right eye of the viewer will not see the left-eye images.

Graph 730 shows the intensity vs. wavelength for a light source that is used in conjunction with a color modulator (e.g. color wheel 300) to provide the left-eye and right-eye images in spectrums consistent with graphs 710 and 720. In one embodiment, the light source is the light source 210 of image projector 200. In one aspect, the spectrum distribution for the filters of the color modulator and glasses are made to get the best color performance and brightness for right and left image based on the lamp spectrum shown in graph 730. For example, the spectrums for the color modulators and the glasses are made to match so that the spectrums for the right-eye lens match the combination of the modulator spectrums designated for the right eye, and similarly for the left eye.

Ideally, the rise and fall of the edges in the spectrums 610-660 and 710-720 are steep, thus allowing no overlap between spectrums for one eye relative to the other eye while maintaining the widths to have high brightness. But, manufacturing such steep cutoffs is difficult. If the separation between peaks is made larger (no overlap), the brightness will be reduced due to a smaller spectrum. In one embodiment, the widths of the spectrums are kept wide, and some overlap (e.g. less than 1% or even less than 5% or 10%) is allowed, even though some ghosting will occur. If the overlap is maintained sufficiently small, the amount of ghosting may be acceptable.

In one embodiment, the brightness difference level between right and left images may be minimized by having neighboring peaks in the spectrum 730 each correspond with different ones of the left and right images.

Embodiments employing the methodology to reduce color shifting may be employed in any type of display, e.g. projection or non-projection (e.g. LCD or plasma), single or double projector, single chip or multiple chip (e.g. one chip for each of R,G, and B), and single light source or multiple light sources, as described herein.

In one embodiment, for a non-projection system, each pixel of an image is created by sub-pixels of different colors, as may occur on a computer monitor. For example, in an LCD monitor each sub-pixel may comprise a liquid crystal molecule (which controls an intensity of light) and a filter that transmits light in a corresponding spectrum. Each of the filters for the sub-pixel may correspond to a filter of a color modulator (e.g. of wheel 300).

In one embodiment, for each pixel, the left-eye image is created by a first set of three sub-pixels and the right-eye image is created by a second set of three sub-pixels. In another embodiment, only one set of sub-pixels may be used, but with filters that change from transmitting a first spectrum to transmitting a second spectrum for each color, respectively. In yet another embodiment, no sub-pixels may be used and the filter may be switched between all of the colors during different time periods.

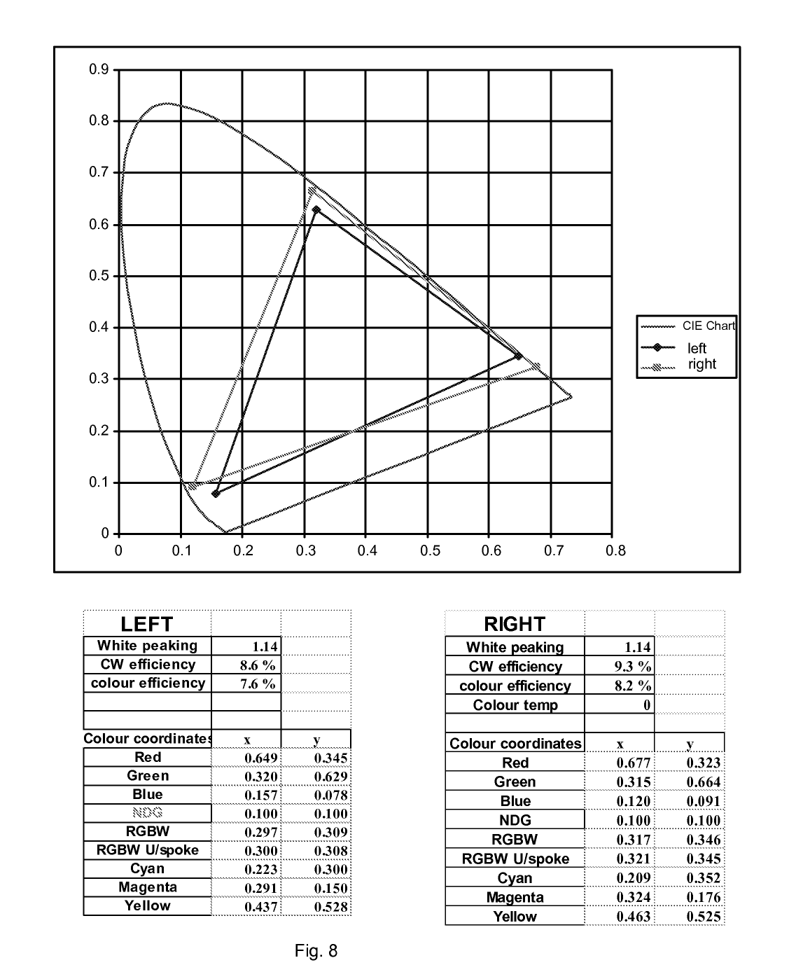

FIG. 8 is a chart of the color coordinates of the image, for right/left eye information according to an embodiment of the present invention. FIG. 8 shows that the white peaking, i.e. the difference in white and the R,G,B values, between the left and right images are essentially equal. Thus, the color shift and brightness levels provide a high quality and consistent images to the left and right eyes. FIG. 8 also shows the CW efficiency (the transmission of the color wheel for right and left image). This shows that the brightness difference between left and right image is also quite small.

The specific details of the specific aspects of the present invention may be combined in any suitable manner without departing from the spirit and scope of embodiments of the invention. However, other embodiments of the invention may be directed to specific embodiments relating to each individual aspects, or specific combinations of these individual aspects.

It should be understood that the present invention as described above can be implemented in the form of control logic using hardware and/or using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive or an entire computer system), and may be present on or within different computer program products within a system or network. A computer system may include a monitor, printer, or other suitable display for providing any of the results mentioned herein to a user.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. An image projector for creating one or more stereoscopic three dimensional images comprising left-eye images and right-eye images, the image projector comprising:
a light source;
an imager that creates left-eye images and right-eye images from at least a portion of the light from the light source;
a color modulator that modulates light transmitted from the light source to the imager and that includes two sets of filters, wherein one filter modulates the light at one instant in time, and wherein the first set of filters includes:
a first red filter that transmits light according to a first red spectral distribution;
a first green filter that transmits light in a first green spectral distribution; and
a first blue filter that transmits light in a first blue spectral distribution;
wherein the second set of filters includes:
a second red filter that transmits light in a second red spectral distribution;
a second green filter that transmits light in a second green spectral distribution; and
a second blue filter that transmits light in a second blue spectral distribution; and a
controller that synchronizes the color modulator with the imager such that:
when a left-eye image is being created by the imager, each one of the first set of filters are used to modulate the light at different time periods during the creation of the left-eye image; and
when a right-eye image is being created by the imager, each one of the second set of filters are used to modulate the light at different time periods during the creation of the right-eye image.

2. The image projector of claim 1, wherein the first red, green, and blue spectral distributions have an overlap of about 10% or less with the second red, green, and blue spectral distributions.

3. The image projector of claim 1, wherein the imager uses a single DLP chip.

4. The image projector of claim 1, wherein the color modulator is a color wheel having at least six segments, wherein each filter of the two sets of filters corresponds to a different segment of the color wheel.

5. The image projector of claim 1, further comprising a projection lens that receives the left-eye and right-eye images and displays the images.

6. A method of creating one or more stereoscopic three dimensional images comprising left-eye images and right-eye images, the method comprising:
creating a left-eye image, wherein the creating includes:
providing, to an imager, light in a first red spectrum during a first time period;
providing, to the imager, light in a first green spectrum during a second time period; and
providing, to the imager, light in a first blue spectrum during a third time period; and
creating a right-eye image, wherein the creating includes:
providing, to the imager, light in a second red spectrum during a fourth time period;
providing, to the imager, light in a second green spectrum during a fifth time period;
providing, to the imager, light in a second blue spectrum during a sixth time period,
wherein the first to sixth time periods do not overlap.

7. The method of claim 6, wherein the first to third time periods occur sequentially in time with any order, and wherein the fourth to sixth time periods occur sequentially in time with any order.

8. The method of claim 6, wherein the first red, green, and blue spectrums have an overlap of about 5% or less with the second red, green, and blue spectrums.

9. The method of claim 6, wherein the imager uses a single DLP chip.

10. The method of claim 6, wherein the light in the spectrums is provided by a light source and a color modulator having at least six filters.

11. The method of claim 10, wherein the color modulator is a color wheel having at least six segments, wherein each filter of the two sets of filters corresponds to a different segment of the color wheel.

12. The method of claim 6, further comprising providing the left-eye and right-eye images to a projection lens and displaying the images with the projection lens.

13. The method of claim 12, wherein the images are displayed such that a viewer sees a three dimensional image when viewing the at least two images through a left eye filter and a right eye filter, wherein the left eye filter does not appreciably transmit light in one of the first spectrums or the second spectrums, and wherein the right eye filter does not appreciably transmit light in the other of the first spectrums or the second spectrums.

14. A method of creating one or more stereoscopic three dimensional images comprising left-eye images and right-eye images, the method comprising:
creating a first image of a stereoscopic three dimensional image by respectively controlling an intensity of light to be displayed in a first red spectrum, a first green spectrum, and a first blue spectrum for a plurality of pixels of the first image;
creating a second image of the stereoscopic three dimensional image by respectively controlling the intensity of light to be displayed in a second red spectrum, a second green spectrum, and a second blue spectrum for a plurality of pixels of the second image, wherein at least one of the first spectrums has at least two peaks that are centered around a peak for the corresponding color of the second spectrum.

15. The method of claim 14, wherein the first image is the left-eye image.

16. The method of claim 14, wherein each of the first red, green, and blue spectrums include two peaks that are respectively centered around a peak of the second red, green, and blue spectrums.

17. The method of claim 16, wherein a color shift between the first image and the second image is minimized.

18. The method of claim 14, wherein the first red, green, and blue spectrums have an overlap of about 5% or less with the second red, green, and blue spectrums.

19. The method of claim 14, wherein the first red spectrum has appreciable values between 630 nm to 690 nm and 580 to 600 nm, wherein the first green spectrum has appreciable values between 500 nm to 540 nm and 565 to 590 nm, wherein the first blue spectrum has appreciable values between 400 nm to 450 nm and 495 to 530 nm, wherein the second red spectrum has appreciable values between 600 nm to 635 nm, wherein the second green spectrum has appreciable values between 480 nm to 500 nm and 535 to 570 nm, and wherein the second blue spectrum has appreciable values between 450 nm to 500 nm.

20. The method of claim 14, wherein the three dimensional image is displayed on a flat panel display, and
wherein for each of a plurality of pixels of the flat panel display,
creating the first image includes using a first three sub-pixels of the pixel to respectively control the intensity of light in the first red spectrum, the first green spectrum, and the first blue spectrum, and
creating the second image includes using a second three sub-pixels of the pixel to respectively control the intensity of light in the second red spectrum, the second green spectrum, and the second blue spectrum.

21. The method of claim 14, wherein creating the first image includes:
providing, to a first imager, light in the first red spectrum, wherein the first imager controls an intensity of received light for a pixel;
providing, to the first imager, light in the first green spectrum; and
providing, to the first imager, light in the first blue spectrum,
wherein creating the second image includes:
providing, to a second imager, light in the second red spectrum;
providing, to the second imager, light in the second green spectrum; and
providing, to the second imager, light in the second blue spectrum.

22. The method of claim 21, wherein the second imager is the first imager.

23. The method of claim 21, wherein the first imager comprises a single imaging device, and wherein the first red spectrum, the first green spectrum, and the first blue spectrum are provided to the single imaging device at different times.

24. The method of claim 21, wherein the first red spectrum is provided by a red light source that produces light in the first red spectrum.

25. The method of claim 24, wherein the red light source is a light emitting diode.

26. The method of claim 21, wherein the first imager comprises three imaging devices, and wherein the first red spectrum is provided to a first imaging device, the first green spectrum is provided to a second imaging device, and the first blue spectrum is provided to a third imaging device, and wherein creating the first image further comprises:
combining outputs of the three imaging devices to create the first image.
